(19) United States
(12) Patent Application Publication
(10) Pub. No.: US 2024/0328846 A1
(43) Pub. Date: Oct. 3, 2024

(54) LIQUID SENSOR

(71) Applicant: NIPPON PILLAR PACKING CO., LTD, Osaka (JP)

(72) Inventors: Kentaro WATANABE, Osaka (JP); Akira NAKATSU, Osaka (JP); Yusuke NATSUHARA, Osaka (JP)

(21) Appl. No.: 18/605,101

(22) Filed: Mar. 14, 2024

(30) Foreign Application Priority Data
Mar. 31, 2023 (JP) 2023057522

(51) Int. Cl. G01F 23/263

(52) U.S. Cl. CPC G01F 23/268; G01F 23/266

(57) ABSTRACT

There is provided a liquid sensor capable of detecting a liquid level with high accuracy regardless of the type and quality of the liquid. The liquid sensor detects a liquid level in a state where at least part of the liquid sensor is immersed in the liquid. The liquid sensor includes a substrate. A plurality of electrodes are formed on the substrate. A first electrode portion is constructed by a first pair of electrodes included in the plurality of electrodes. A second electrode portion is constructed by a second pair of electrodes included in the plurality of electrodes. A hole is formed in the substrate. The first pair of electrodes are formed on the inner peripheral surface of the substrate formed by the hole. In a state where the liquid sensor is immersed in the liquid, the second electrode portion is positioned below the first electrode portion.

### TECHNICAL FIELD

The present invention relates to a liquid sensor.

### BACKGROUND ART

Japanese Patent Application Laid-Open No. 2021-131273 (Patent Document 1) discloses a liquid sensor. This liquid sensor detects the level of a liquid (hereinafter “liquid level”) in a state where at least part of the sensor is immersed in the liquid. This liquid sensor includes a substrate and has a hole formed in the substrate. A first electrode and a second electrode that faces the first electrode are formed on an inner peripheral surface of the substrate formed by the hole. The electrical capacitance between the first and second electrodes changes in keeping with the liquid level. With this liquid sensor, the liquid level is detected based on the capacitance between the first and second electrodes (see Patent Document 1).
Japanese Patent Application Laid-Open No. 2021-131273 is an example of related art.

### SUMMARY OF THE INVENTION

With the liquid sensor disclosed in Patent Document 1 described above, the liquid level is detected based on a capacitance between a pair of electrodes. However, the dielectric constant of a liquid will vary according to the type or quality of the liquid for example. This means that even when the liquid level is the same, if the type or quality of the liquid differs, the capacitance between the pair of electrodes may differ. Accordingly, the accuracy when detecting a liquid level using the liquid sensor disclosed in Patent Document 1 described above will fall depending on the type or quality of the liquid.

The present invention was conceived to solve the problem described above and it is an object of the present invention to provide a liquid sensor capable of detecting a liquid level with high accuracy regardless of the type or quality of a liquid.

A liquid sensor according to the present invention detects a liquid level in a state where at least part of the liquid sensor is immersed in a liquid. The liquid sensor includes a substrate. A plurality of electrodes are formed on the substrate. A first electrode portion is composed of a first pair of electrodes included in the plurality of electrodes. A second electrode portion is composed of a second pair of electrodes included in the plurality of electrodes. A hole is formed in the substrate. The first pair of electrodes are formed on an inner peripheral surface of the substrate formed by the hole. The second electrode portion is positioned below the first electrode portion in a state where the liquid sensor is immersed in the liquid.

With this liquid sensor, the second electrode portion is positioned below the first electrode portion when the liquid sensor is immersed in the liquid. Accordingly, when at least part of the first electrode portion is immersed in the liquid, the entire second electrode portion will be immersed in the liquid. As one example, when the liquid level is detected based on changes in capacitance at the first electrode portion, when the liquid level is present within a range that can be detected by the liquid sensor, the entire second electrode portion will be immersed in the liquid. Since the entire second electrode portion is immersed in the liquid, the differences in dielectric constant between liquids can be detected based on the capacitance at the second electrode portion. This means that according to this liquid sensor, it is possible to detect the liquid level with higher accuracy having taken into consideration the differences in dielectric constant between liquids.

The liquid sensor described above may further include a detection circuit that detects a first capacitance at the first electrode portion and a second capacitance at the second electrode portion, and the detection circuit may detect the liquid level based on the first capacitance and the second capacitance.

According to this liquid sensor, since the liquid level is detected based on the first and second capacitances, it is possible to detect the liquid level with higher accuracy compared to when the liquid level is detected based on only the first capacitance, for example.

In the liquid sensor described above, the detection circuit may correct the first capacitance based on the second capacitance and detect the liquid level based on the first capacitance after correction.

According to the liquid sensor described above, since the first capacitance is corrected based on the second capacitance and the liquid level is detected based on the corrected first capacitance, it is possible to detect the liquid level with higher accuracy compared to when the liquid level is detected based on only the first capacitance, for example.

In the liquid sensor described above, the detection circuit may detect the liquid level based on the first capacitance and correct the detected liquid level based on the second capacitance.

According to the liquid sensor described above, since the liquid level is detected based on the first capacitance and the detected liquid level is corrected based on the second capacitance, it is possible to detect the liquid level with higher accuracy compared to when the liquid level is detected based on only the first capacitance, for example.

In the liquid sensor described above, the detection circuit may detect an abnormality at the liquid sensor based on the second capacitance.

The range of the second capacitance when an abnormality has not occurred at the liquid sensor is known in advance. That is, by referring to the second capacitance, the occurrence of some kind of abnormality at the liquid sensor can be detected with relatively high accuracy. According to this liquid sensor, since an abnormality at the liquid sensor is detected based on the second capacitance, it is possible to detect an abnormality at the liquid sensor with relatively high accuracy.

In the liquid sensor described above, a third electrode portion may be constructed by a pair of third electrodes included in the plurality of electrodes, the pair of third electrodes may be formed on the inner peripheral surface of the substrate, the third electrode portion may be positioned below the first electrode portion in a state where the liquid sensor is immersed in the liquid, the detection circuit may detect a third capacitance at the third electrode portion, and the detection circuit may detect an abnormality at the liquid sensor based on the third capacitance.

The range of the third capacitance when an abnormality has not occurred at the liquid sensor is known in advance. That is, by referring to the third capacitance, the occurrence of some kind of abnormality at the liquid sensor can be detected with relatively high accuracy. According to this liquid sensor, since an abnormality at the liquid sensor is detected based on the third capacitance, it is possible to detect an abnormality at the liquid sensor with relatively high accuracy.

In the liquid sensor described above, a wire that electrically connects the second electrode portion and the detection circuit may be formed on the substrate, at least part of the wire may extend along the first pair of electrodes, and at least part of the wire may be formed in an inner layer of the substrate.

If the wire connecting the second electrode portion and the detection circuit extends along the first pair of electrodes, forming the wire on the substrate may result in the second capacitance being affected by the liquid level. According to this liquid sensor, since at least part of the wire is formed in an inner layer of the substrate, it is possible to suppress the influence of the liquid level on the second capacitance.

The liquid sensor described above may further include a temperature sensor mounted on the substrate, and the detection circuit may switch an operating state in keeping with a detection result of the temperature sensor.

In this liquid sensor, the operating state is switched depending on the temperature. Accordingly, with this liquid sensor, product deterioration can be suppressed by stopping detection operations when the temperature has deviated from a predetermined temperature range, for example.

The liquid sensor described above may further include a temperature sensor mounted on the substrate, and the detection circuit may correct at least one of the first capacitance and the second capacitance based on a detection result of the temperature sensor.

The respective capacitances at each of the first and second electrode portions are affected by temperature for reasons such as the distance between the electrodes changing depending on the temperature. In this liquid sensor, at least one of the first capacitance and the second capacitance is corrected based on the detection result of the temperature sensor. Accordingly, with this liquid sensor, since the influence of temperature on at least one of the first capacitance and the second capacitance is taken into consideration, the liquid level can be detected with higher accuracy than when the influence of temperature is not taken into consideration.

The liquid sensor described above may further include an angle sensor, and the detection circuit may correct the detected liquid level based on a detection result of the angle sensor.

According to this liquid sensor, since the detected liquid level is corrected based on the detection result of the angle sensor, the liquid level can be detected with higher accuracy than when tilting of the liquid sensor is not taken into consideration.

According to the present invention, it is possible to provide a liquid sensor capable of detecting a liquid level with high accuracy regardless of the type and quality of a liquid.

### BRIEF DESCRIPTION OF THE DRAWINGS

FIG. 1 schematically depicts the configuration of a liquid sensor.

FIG. 2 is a schematic cross sectional view taken along a line II-II in FIG. 1.

FIG. 3 is a plan view schematically depicting a substrate.

FIG. 4 is a schematic cross sectional view taken along a line IV-IV in FIG. 3.

FIG. 5 is a schematic cross sectional view taken along a line V-V in FIG. 3.

FIG. 6 is a flowchart depicting a manufacturing procedure of a substrate.

FIG. 7 is a diagram illustrating a procedure for detecting a liquid level with a liquid sensor.

FIG. 8 is a diagram illustrating the concept behind the correction coefficient Δεᵣ used in the liquid sensor S1.

FIG. 9 is a flowchart depicting the procedure for detecting a liquid level with a liquid sensor.

FIG. 10 depicts the relationship between liquid levels and capacitance values for a liquid sensor.

FIG. 11 is a flowchart depicting a procedure for detecting a first abnormality.

FIG. 12 is a flowchart depicting a procedure for detecting a second abnormality.

FIG. 13 is a flowchart depicting a procedure for detecting a third abnormality.

FIG. 14 is a flowchart depicting a procedure for detecting a liquid level with a liquid sensor according to a first alternative embodiment.

FIG. 15 depicts the relationship between the liquid level and values of capacitance in a case where the liquid level is regarded as zero in a state where the liquid surface is present at a position slightly above a lower end of the first electrode portion.

FIG. 16 is a flowchart depicting a procedure for detecting a second abnormality for a liquid sensor according to a second alternative embodiment.

FIG. 17 is a plan view schematically depicting a substrate included in a liquid sensor according to a third alternative embodiment.

FIG. 18 is a flowchart depicting a procedure for detecting a second abnormality for a liquid sensor according to the third alternative embodiment.

FIG. 19 is a plan view schematically depicting a substrate included in a liquid sensor according to a fourth alternative embodiment.

FIG. 20 is a plan view schematically depicting a substrate included in a liquid sensor according to a fifth alternative embodiment.

FIG. 21 is a flowchart depicting an operating procedure of a liquid sensor according to a fifth alternative embodiment.

FIG. 22 is a diagram illustrating a procedure for detecting a liquid level with a liquid sensor according to a sixth alternative embodiment.

FIG. 23 is a flowchart depicting a procedure for correcting a liquid level by a liquid sensor according to the sixth alternative embodiment.

### EMBODIMENTS OF THE INVENTION

A preferred embodiment (hereinafter also referred to as “the present embodiment”) according to one aspect of the present invention will now be described in detail with reference to the drawings. Parts in the drawings that are the same or correspond to each other have been assigned the same reference numerals, and description thereof will not be repeated. For ease of understanding, the respective drawings have been schematically drawn with objects omitted or exaggerated as appropriate.

### 1. Configuration

### 1-1. Configuration of Liquid Sensor

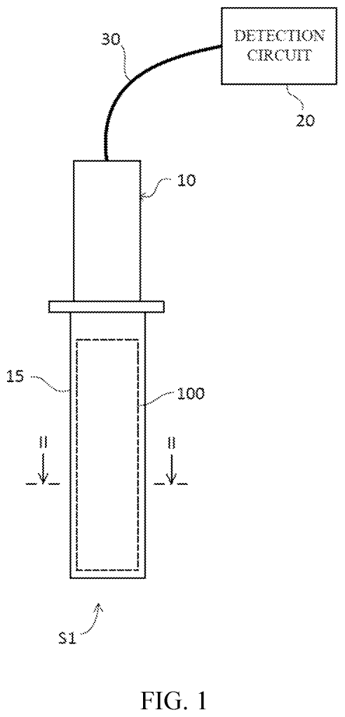

FIG. 1 is a diagram schematically depicting the configuration of a liquid sensor S1 according to an embodiment. As one example, the liquid sensor S1 is installed in the oil tank of a vehicle or the like, and is configured to electrically detect a remaining amount (or “liquid level”) of fuel (or oil). The liquid sensor S1 detects the liquid level in a state where at least part of the liquid sensor S1 is immersed in a liquid such as fuel (hereinafter simply referred to as the “liquid”).

As depicted in FIG. 1, the liquid sensor S1 includes a liquid sensor main body 10, a detection circuit 20, and a cable 30. In the liquid sensor main body 10, a substrate 100 is housed inside a plug 15. The substrate 100 and the detection circuit 20 are electrically connected via the cable 30. As one example, the detection circuit 20 includes a CPU (Central Processing Unit), a RAM (Random Access Memory), and a ROM (Read Only Memory). Note that the substrate 100 and the detection circuit 20 do not need to be connected via the cable 30. As one example, the substrate 100 and the detection circuit 20 may be electrically connected by being mounted on the same substrate.

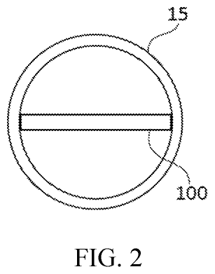

FIG. 2 schematically depicts a cross section taken along a line II-II in FIG. 1. As depicted in FIG. 2, the plug 15 is shaped like a tube, and the substrate 100 is housed inside the plug 15. Since the plug 15 is tube-shaped, liquid will flow into the plug 15 when the liquid sensor main body 10 is immersed in the liquid. As described in detail later, a plurality of electrodes are formed on the substrate 100. The capacitance between a pair of electrodes included in this plurality of electrodes changes depending on the remaining amount of liquid (that is, the liquid level). The detection circuit 20 depicted in FIG. 1 detects the capacitance between a pair of electrodes by using various known techniques. The detection circuit 20 detects the liquid level based on the detected capacitance.

As described in detail later, the dielectric constant of the liquid varies depending on the type or quality of the liquid, for example. That is, even when the liquid level is the same, the capacitance between the pair of electrodes may differ if the type or quality of the liquid differs. Accordingly, when a liquid level is detected based on a relationship between liquid level and capacitance that has been uniformly set in advance without consideration to differences in the type or quality of the liquid, the liquid level may be erroneously detected. In the liquid sensor S1 according to the present embodiment, the influence of this problem is suppressed by modifying the configuration of the substrate 100. The configuration of the substrate 100 will now be described in detail.

### 1-2. Configuration of Substrate

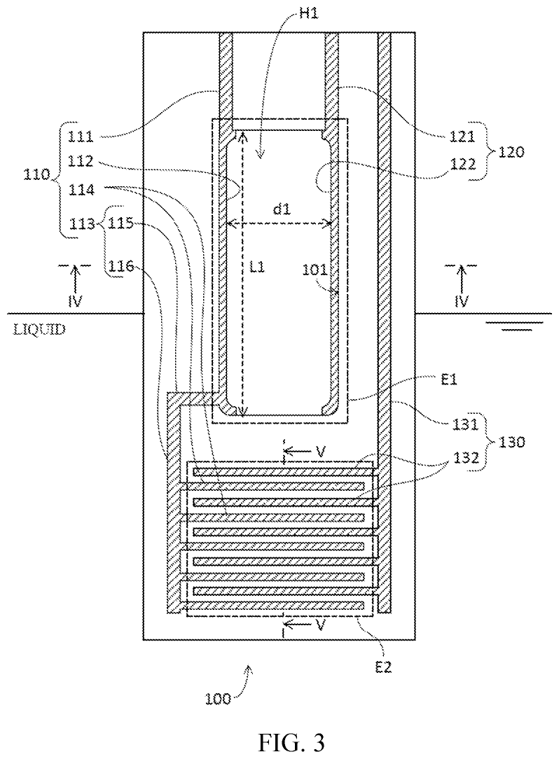

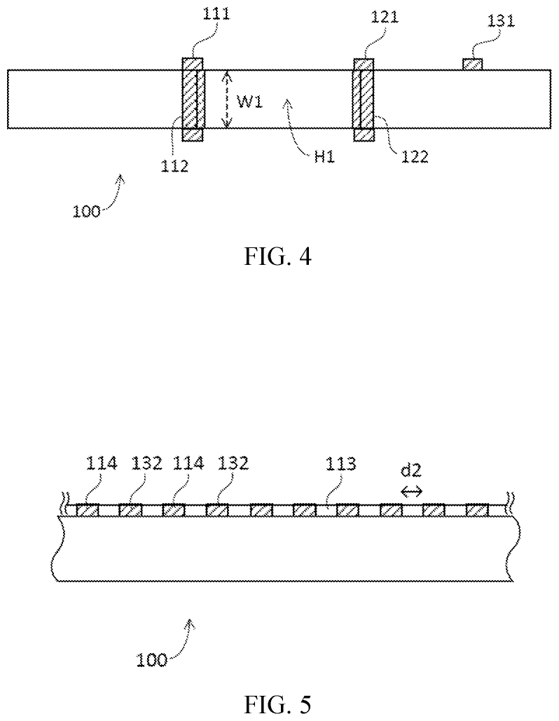

FIG. 3 is a plan view schematically depicting the substrate 100. FIG. 4 is a diagram schematically depicting a cross section taken along the line IV-IV in FIG. 3. FIG. 5 is a diagram schematically depicting a cross section taken along the line V-V in FIG. 3. As depicted in FIGS. 3, 4, and 5, the shape of the substrate 100 is substantially rectangular with long sides and short sides. The substrate 100 is a so-called “fluororesin substrate”. A fluororesin substrate has excellent weather and chemical resistance, which means that the substrate 100 can withstand use in harsh environments. Note that although the substrate 100 does not have to be made of a fluorine substrate, it is preferable for the substrate 100 to be composed of a substrate with superior chemical resistance, for example.

A hole H1 is formed at the position that is approximately the center in the minor axis direction of the substrate 100 (hereinafter also simply referred to as the “minor axis direction”) and slightly above the center in the major axis direction of the substrate 100 (hereinafter also simply referred to as the “major axis direction”). The shape of the hole H1 is substantially rectangular with long sides and short sides. The long sides of the hole H1 extend along the long sides of the substrate 100, and the short sides of the hole H1 extend along the short sides of the substrate 100. An inner peripheral surface 101 of the substrate 100 is located around the hole H1.

A conductive portion 110, a conductive portion 120, and a conductive portion 130 are formed on the substrate 100. The conductive portions 110, 120, and 130 are each made of a conductive material, such as gold, silver, copper, or aluminum. The conductive portions 110, 120, and 130 may each be coated with fluororesin, for example. The conductive portion 110 includes an electrode 112, a wire 111, a wire 113, and a plurality of electrodes 114. The conductive portion 120 includes an electrode 122 and a wire 121. The conductive portion 130 includes a plurality of electrodes 132 and a wire 131.

The electrode 112 included in the conductive portion 110 is formed on an entire surface that extends along one long side of the hole H1, out of the inner peripheral surface 101 of the substrate 100. The electrode 122 included in the conductive portion 120 is formed on an entire surface that extends along the other long side of the hole H1, out of the inner peripheral surface 101 of the substrate 100. The electrodes 112 and 122 face each other. The electrodes 112 and 122 are separated from each other at the surfaces that extend along the short sides of the hole H1 out of the inner peripheral surface 101. The electrodes 112 and 122 compose a “first electrode portion E1”.

The length of the respective electrodes 112 and 122 in the major axis direction is a length L1, and the length of the respective electrodes 112 and 122 in the thickness direction of the substrate 100 is a length W1 (see FIG. 4). The distance between the electrodes 112 and 122 is a distance d1. This distance d1 between the electrodes 112 and 122 is preferably sufficiently large for fuel to not be held by surface tension between the electrodes 112 and 122 after the liquid level has fallen.

Note that the electrode 112 does not need to be formed along an entire surface that extends along one long side of the hole H1 on the inner peripheral surface 101, and it is sufficient for the electrode 112 to be formed on at least a part of this surface that extends along one long side of the hole H1 on the inner peripheral surface 101. Likewise, the electrode 122 does not need to be formed along an entire surface that extends along the other long side of the hole H1 on the inner peripheral surface 101, and it is sufficient for the electrode 122 to be formed on at least a part of this surface that extends along the other long side of the hole H1 on the inner peripheral surface 101.

The wires 111 and 121 are each formed on a main surface of the substrate 100 and extend in the major axis direction. The wire 111 is electrically connected to one end, out of the two ends in the major axis direction of the electrode 112, at the opposite end to the plurality of electrodes 114, and is also electrically connected to the detection circuit 20 (see FIG. 1). The wire 121 is electrically connected to one end, out of the two ends in the major axis direction of the electrode 122, at the opposite end to the plurality of electrodes 114, and is also electrically connected to the detection circuit 20.

When the liquid sensor S1 is used (see FIG. 1), the substrate 100 is disposed so that the long sides of the substrate 100 extend in a direction perpendicular to the liquid surface. As the height of the liquid surface (or “liquid level”) changes, the amount of liquid positioned between the electrodes 112 and 122 changes. As a result, the dielectric constant of the substance present between the electrodes 112 and 122 will change, so that the capacitance between the electrodes 112 and 122 (hereinafter also referred to as the “first capacitance”) will change. The detection circuit 20 stores the relationship between first capacitances and liquid levels in advance, and detects the liquid level based on the first capacitance. A specific example of a procedure for detecting a liquid level is described in detail later.

The wire 113 included in the conductive portion 110 is formed on a main surface of the substrate 100, and includes a first part 115 that extends in the minor axis direction and a second part 116 that extends in the major axis direction. One end of the first part 115 is electrically connected to the electrode 112 near an end, out of both ends of the electrode 112 in the length direction, on the opposite side to the wire 111. The second part 116 extends from the other end of the first part 115 toward the opposite side in the major axis direction to the wire 111 side. The wire 131 included in the conductive portion 130 is formed on the surface of the substrate 100 and extends in the major axis direction. The wire 121 is positioned between the wire 111 and the wire 131 in the minor axis direction.

Each of the plurality of electrodes 114 included in the conductive portion 110 extends from the second part 116 of the wire 113 in the minor axis direction toward the wire 131. The plurality of electrodes 114 construct a first comb electrode. Each of the plurality of electrodes 132 included in the conductive portion 130 extends from the wire 131 in the minor axis direction toward the second part 116 of the wire 113. The plurality of electrodes 132 construct a second comb electrode. In the major axis direction, the electrodes 114 and 132 are alternately formed at regular intervals (see FIG. 5). A distance d2 between the electrodes 114 and 132 in the major axis direction is shorter than the distance d1 between the electrodes 112 and 122 in the minor axis direction.

A second electrode portion E2 is constructed by the plurality of electrodes 114 (or “first comb electrode”) and the plurality of electrodes 132 (or “second comb electrode”). In a state where the liquid sensor S1 is immersed in a liquid, the second electrode portion E2 is positioned below the first electrode portion E1. The detection circuit 20 detects the capacitance between the electrodes 114 and 132 (hereinafter also referred to as the “second capacitance”) using various known techniques. The reason why the second electrode portion E2 is provided on the substrate 100 is described in detail later.

### 2. Manufacturing Method of Substrate

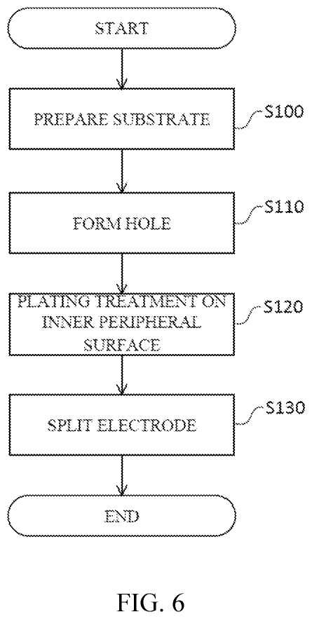

FIG. 6 is a flowchart depicting the manufacturing procedure of the substrate 100. The processing depicted in FIG. 6 is executed by a manufacturing apparatus for the substrate 100, for example.

With reference to FIG. 6, the manufacturing apparatus prepares a substrate on which the wires 111, 113, 121, 131, the plurality of electrodes 114, and the plurality of electrodes 132 have been printed on the main surface (step S100). The manufacturing apparatus forms the hole H1 in the substrate by punching with a router or a press (step S110). The manufacturing apparatus performs a plating process on the inner peripheral surface 101 around the hole H1 (step S120). The manufacturing apparatus separates the electrodes 112 and 122 by forming gaps between the electrodes 112 and 122 with a router or punching with a press (step S130). By doing so, the substrate 100 is completed.

### 3. Increasing Accuracy of Liquid Level Detection

As described earlier, in the liquid sensor S1, the liquid level is detected based on the capacitance (or “first capacitance”) at the first electrode portion E1. In the detection circuit 20, a relational equation indicating the relationship between the first capacitance and the liquid level is stored in advance. The relational equation stored in the detection circuit 20 indicates the relationship between the first capacitance and the liquid level for a liquid used as a standard (hereinafter also referred to as the “reference liquid”).

On the other hand, the dielectric constant of a liquid will vary depending for example on the type or quality of the liquid. The relationship between the first capacitance and the liquid level is expressed by Equation (1) below.

$$C = {ε}_{0} \times {ε}_{r} \times L \times W 1 / d 1 \qquad ( 1 )$$

In Equation (1), C represents the first capacitance. ε₀ represents the dielectric constant of a vacuum, and εᵣ represents the relative dielectric constant of a liquid. L indicates the length (or “liquid level”) in the major axis direction of the part of the first electrode portion E1 that is immersed in the liquid. W1 represents the thickness of the substrate 100, and d1 represents the distance between the electrodes 112 and 122.

As can be understood from Equation (1), if the type or quality of the liquid differs from the reference liquid so that the relative dielectric constant of the liquid differs from the dielectric constant of the reference liquid, the relationship between the first capacitance and the liquid level will also change. Accordingly, if the liquid level is uniformly detected based on a relational equation without considering differences in the type or quality of the liquid, the liquid level may be erroneously detected. To suppress such erroneous detection of the liquid level, differences in the dielectric constant between liquids are taken into consideration by the liquid sensor S1.

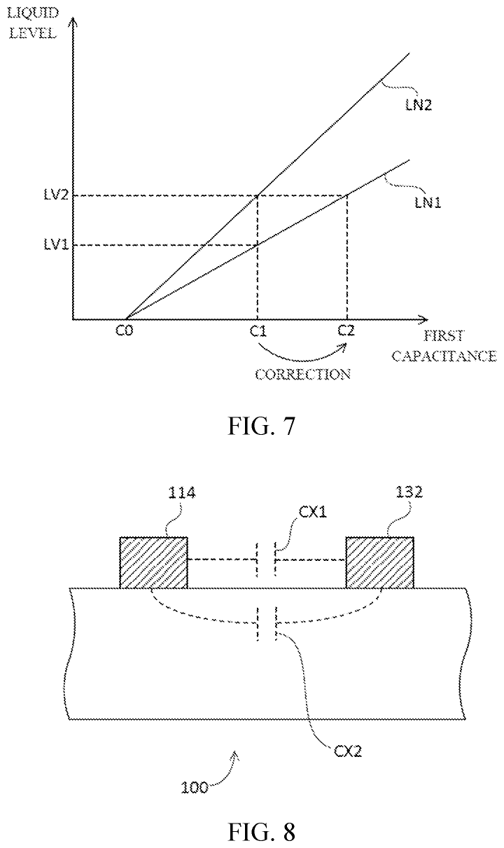

FIG. 7 is a diagram illustrating the procedure for detecting a liquid level with the liquid sensor S1. In FIG. 7, the horizontal axis represents the first capacitance and the vertical axis represents the liquid level. The line LN1 depicts an example of the relationship between the first capacitance and the liquid level for the reference liquid, and the line LN2 depicts an example of the relationship between the first capacitance and the liquid level for a liquid whose liquid level is being detected (hereinafter also referred to as the “target liquid”). Here, the relationship indicated by the line LN1 corresponds to the relationship indicated by the relational equation stored in the detection circuit 20.

As one example, assume that the actual liquid level of the target liquid is LV2. In this case, at the liquid sensor S1, C1 is detected as the first capacitance. When C1 has been detected as the first capacitance and the liquid level is uniformly detected based on a relational equation, LV1 is detected as the liquid level. Since the actual liquid level is LV2, this detection result is incorrect. For this reason, at the liquid sensor S1, the first capacitance is corrected before substitution into the relational equation. That is, at the liquid sensor S1, C1 that was detected as the first capacitance is corrected to C2, and the liquid level is detected by substituting this corrected first capacitance C2 into the relational equation. By doing so, the liquid sensor S1 detects the correct value LV2 as the liquid level.

The second capacitance is used to correct the first capacitance. In a state where the liquid sensor S1 has been immersed in the liquid, the second electrode portion E2 is positioned below the first electrode portion E1. Accordingly, when at least part of the first electrode portion E1 has been immersed in the liquid, the entire second electrode portion E2 will be immersed in the liquid. In the liquid sensor S1, since the liquid level is detected based on changes in the first capacitance, when the liquid level is present within a range that can be detected by the liquid sensor S1, the entire second electrode portion E2 will be immersed in the liquid.

The detection circuit 20 detects the second capacitance Cb for when the entire second electrode portion E2 is immersed in the “target liquid”. On the other hand, in the detection circuit 20, the second capacitance Ca when the entire second electrode portion E2 is immersed in the “reference liquid” is stored in advance. The detection circuit 20 calculates the ratio between the second capacitance Ca and the second capacitance Cb, and corrects the first capacitance by using the calculated ratio as a correction coefficient Δεᵣ. Note that in calculating the correction coefficient Δεr, the parasitic capacitance of the substrate 100 may or may not be taken into consideration.

FIG. 8 is a diagram illustrating the concept behind the correction coefficient Δεᵣ used in the liquid sensor S1. With reference to FIG. 8, the second capacitance detected by the detection circuit 20 is the sum of a capacitance CX1 between the electrodes 114 and 132 via the liquid and a capacitance between the electrodes 114 and 132 via the substrate 100 (that is, a parasitic capacitance CX2 of the substrate 100). When the parasitic capacitance of the substrate 100 is taken into consideration when calculating the correction coefficient Δεᵣ, the correction coefficient Δεᵣ is calculated based on Equation (2) below. In this case, as one example, the value of the parasitic capacitance CX2 is stored in the detection circuit 20 in advance.

$$Δ {ε}_{r} = ( C a - CX 2 ) / ( Cb - CX 2 ) \qquad ( 2 )$$

On the other hand, when the parasitic capacitance of the substrate 100 is not taken into consideration when calculating the correction coefficient Δεᵣ, the correction coefficient Δεᵣ is calculated based on Equation (3) below.

$$Δ {ε}_{r} = Ca / Cb \qquad ( 3 )$$

Referring again to FIG. 7, the detection circuit 20 corrects the first capacitance by multiplying the detected first capacitance C1 by the correction coefficient Δεᵣ. By doing so, the first capacitance is corrected from C1 to C2 and the liquid level LV2 is detected based on the corrected first capacitance C2.

As described above, in the liquid sensor S1 according to the present embodiment, the second electrode portion E2 is positioned below the first electrode portion E1 when the liquid sensor S1 is immersed in the liquid. When the liquid level is present in a range that can be detected by the liquid sensor S1, the second electrode portion E2 will be entirely immersed in the liquid, so that the difference in the dielectric constant between liquids is detected based on the second capacitance. In this way, according to the liquid sensor S1, the liquid level can be detected with higher accuracy having taken into consideration the differences in dielectric constant between liquids.

### 4. Operation

### 4-1. Liquid Level Detection Operation

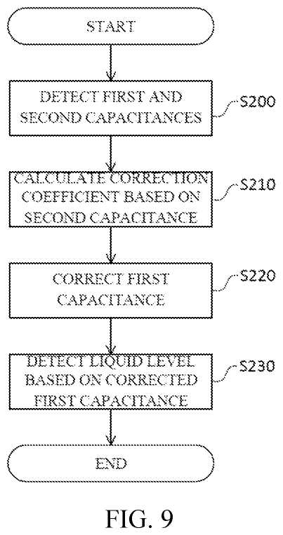

FIG. 9 is a flowchart depicting the procedure for detecting a liquid level with the liquid sensor S1. As one example, the processing depicted in this flowchart is executed by the detection circuit 20 at a predetermined cycle.

With reference to FIG. 9, the detection circuit 20 detects the first and second capacitances (step S200). In more detail, the detection circuit 20 detects the first capacitance in a state where a voltage is applied between the conductive portions 110 and 120, and detects the second capacitance in a state where a voltage is applied between the conductive portions 110 and 130.

The detection circuit 20 calculates a correction coefficient based on the detected second capacitance (step S210). The detection circuit 20 corrects the first capacitance detected in step S200 using this calculated correction coefficient (step S220). The detection circuit 20 detects the liquid level based on the corrected first capacitance (step S230). In more detail, the detection circuit 20 detects the liquid level by substituting the corrected first capacitance into the relational equation.

In this way, with the liquid sensor S1, the liquid level is detected based on the first and second capacitances. That is, with the liquid sensor S1, the liquid level is detected with consideration to the differences in dielectric constant between liquids. This means that compared for example to when liquid level is detected based on only the first capacitance, the liquid level can be detected by the liquid sensor S1 with higher accuracy.

In more detail, with the liquid sensor S1, the first capacitance is corrected based on the second capacitance, and the liquid level is detected based on the corrected first capacitance. That is, with the liquid sensor S1, the first capacitance is corrected with consideration to the differences in dielectric constant between liquids, and the liquid level is detected based on this corrected first capacitance. This means that compared to when a liquid level is detected based on only the first capacitance for example, the liquid level can be detected by the liquid sensor S1 with higher accuracy.

### 4-2. Error Judgment Operation

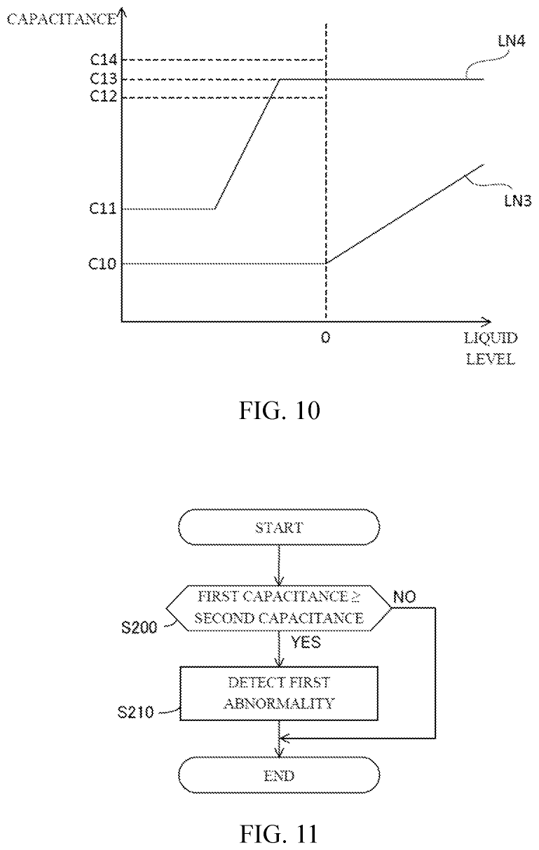

FIG. 10 depicts the relationship between liquid levels and capacitance values for the liquid sensor S1. In FIG. 10, the horizontal axis indicates the liquid level and the vertical axis indicates the capacitance. The line LN3 indicates the relationship between the liquid level and the first capacitance, and the line LN4 indicates the relationship between the liquid level and the second capacitance. The liquid sensor S1 is designed so that a relationship where the first capacitance<the second capacitance holds during normal operation.

The first capacitance is C10 when the liquid level is 0 or lower. That is, the first capacitance when no liquid is present between the electrodes 112 and 122 is C10. In a range where the liquid level is 0 or higher, the higher the liquid level, the larger the first capacitance.

The second capacitance is C11 when the liquid level is less than zero and none of the second electrode portion E2 is immersed in the liquid. That is, the second capacitance is C11 when no liquid is present between the electrodes 114 and 132. As the liquid level rises and the range of the second electrode portion E2 immersed in the liquid increases, the second capacitance increases. The second capacitance in a state where the second electrode portion E2 is entirely immersed in the liquid is C13. A lower limit that is tolerated for the second capacitance in a state where the second electrode portion E2 is entirely immersed in the liquid is C12 and an upper limit that is tolerated for the second capacitance in a state where the second electrode portion E2 is entirely immersed in a liquid is C14.

In this way, with the liquid sensor S1, the relationship depicted in FIG. 10 holds. Accordingly, when a relationship where for example the first capacitance≥the second capacitance holds, there is a high probability that an abnormality has occurred at the liquid sensor S1. In this case, as one example, there is a high probability that an abnormality where foreign matter is present between the electrodes 112 and 122 (hereinafter also referred to as the “first abnormality”) has occurred.

As another example, if a relationship where for example the second capacitance<C12 holds, there is a high probability of an abnormality where at least part of the second electrode portion E2 is not immersed in the liquid (hereinafter also referred to as the “second abnormality”) has occurred. As yet another example, if a relationship where for example the second capacitance>C14 holds, there is a high probability of an abnormality where a large amount of water is present in addition to the target liquid (hereinafter also referred to as the “third abnormality”) has occurred. The error judgment operation described below is performed by the liquid sensor S1 with consideration to the potential abnormalities described above. Note that the error judgment operation described below does not need to be performed.

FIG. 11 is a flowchart depicting a procedure for detecting the first abnormality. The processing depicted in this flowchart is executed by the detection circuit 20 whenever the first and second capacitances are detected, for example.

With reference to FIG. 11, the detection circuit 20 judges whether a relationship where the first capacitance≥the second capacitance holds (step S200). When it has been determined that the relationship where the first capacitance≥the second capacitance does not hold (NO in step S200), the detection circuit 20 stands by until the first and second capacitances are detected again. On the other hand, when it has been determined that the relationship where first capacitance≥second capacitance holds (YES in step S200), the detection circuit 20 detects the first abnormality (step S210).

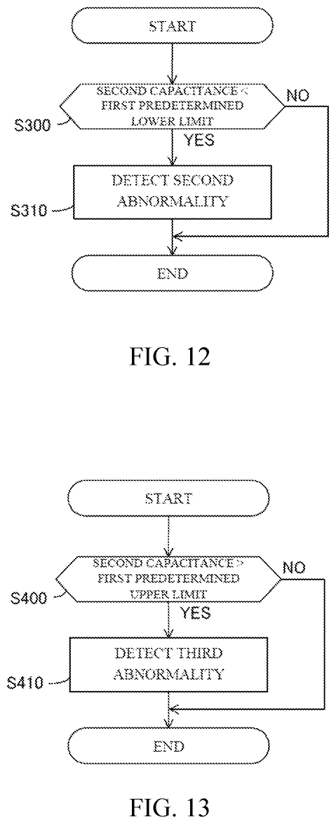

FIG. 12 is a flowchart depicting a procedure for detecting the second abnormality. The processing depicted in this flowchart is executed by the detection circuit 20 whenever the second capacitance is detected, for example.

As depicted in FIG. 12, the detection circuit 20 judges whether a relationship where the second capacitance<a first predetermined lower limit (as one example, C12 in FIG. 10) holds (step S300). When it has been determined that the relationship where the second capacitance<the first predetermined lower limit does not hold (NO in step S300), the detection circuit 20 stands by until the second capacitance is detected again. On the other hand, when it has been determined that the relationship where the second capacitance<the first predetermined lower limit holds (YES in step S300), the detection circuit 20 detects the second abnormality (step S310).

FIG. 13 is a flowchart depicting a procedure for detecting the third abnormality. The processing depicted in this flowchart is executed by the detection circuit 20 whenever the second capacitance is detected, for example.

With reference to FIG. 13, the detection circuit 20 judges whether a relationship where the second capacitance>a first predetermined upper limit (as one example, C14 in FIG. 10) holds (step S400). When it has been determined that the relationship where the second capacitance>the first predetermined upper limit does not hold (NO in step S400), the detection circuit 20 stands by until the second capacitance is detected again. On the other hand, when it has been determined that the relationship where the second capacitance>the first predetermined upper limit holds (YES in step S400), the detection circuit 20 detects the third abnormality (step S410).

In this way, with the liquid sensor S1, the range of the second capacitance when no abnormality has occurred is known in advance. That is, by referring to at least the second capacitance, it is possible to detect with relatively high accuracy that some kind of abnormality has occurred for the liquid sensor S1. According to the liquid sensor S1, since an abnormality for the liquid sensor S1 is detected based on at least the second capacitance, it is possible to detect abnormalities for the liquid sensor S1 with relatively high accuracy.

### 5. Features

As described above, with the liquid sensor S1 according to the present embodiment, when the liquid sensor S1 is immersed in a liquid, the second electrode portion E2 will be positioned below the first electrode portion E1. Accordingly, when at least part of the first electrode portion E1 is immersed in a liquid, the entire second electrode portion E2 will be immersed in the liquid. As one example, if, when the liquid level is detected based on a change in the first capacitance, the liquid level is present within a range that can be detected by the liquid sensor S1, the second electrode portion E2 will be entirely immersed in the liquid. Since the second electrode portion E2 is entirely immersed in the liquid, the differences in dielectric constant between liquids can be detected by comparing the second capacitance. Accordingly, with the liquid sensor S1, the liquid level can be detected with higher accuracy while taking into consideration the differences in dielectric constant between liquids.

### 6. Other Embodiments

The technical concept of the embodiments is not limited to the embodiments described above. As one example, at least part of the configuration of any of the embodiments may be combined with at least part of the configuration of any of the other embodiments. Examples of other embodiments to which the technical concept of the above embodiments can be applied are described below.

6-1

In the embodiments described above, the first capacitance is corrected based on the second capacitance, and the liquid level is detected based on the corrected first capacitance. However, this procedure does not need to be performed when detecting the liquid level. As one example, the liquid level may be detected based on the first capacitance, and the detected liquid level may be corrected based on the second capacitance.

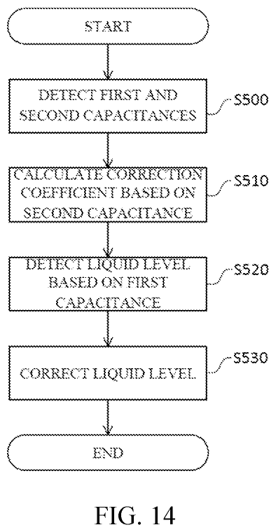

FIG. 14 is a flowchart depicting a procedure for detecting a liquid level with a liquid sensor according to a first alternative embodiment. The processing depicted in this flowchart may be executed by the detection circuit 20 at a predetermined cycle, for example.

As depicted in FIG. 14, the detection circuit 20 detects first and second capacitances (step S500). The detection circuit 20 calculates a correction coefficient based on the detected second capacitance (step S510). The detection circuit 20 detects the liquid level based on the detected first capacitance (step S520). In more detail, the detection circuit 20 detects the liquid level by substituting the first capacitance into a relational equation. The detection circuit 20 corrects the liquid level detected in step S520 using the correction coefficient calculated in step S510 (step S530). As one example, the detection circuit 20 corrects the liquid level by multiplying the liquid level detected in step S520 by the correction coefficient calculated in step S510. Note that the correction coefficient may be calculated using the same method as the embodiments described above.

In this way, with the liquid sensor according to the first alternative embodiment, the liquid level is detected based on the first capacitance and the detected liquid level is corrected based on the second capacitance. That is, with this liquid sensor, the liquid level is corrected with consideration to the differences in dielectric constant between liquids. Accordingly, with this liquid sensor, the liquid level can be detected with higher accuracy compared for example to when the liquid level is detected based on only the first capacitance.

6-2

It is also possible to perform different error judgments from the error judgment described in the above embodiments. As one example, with the liquid sensor S1 according to the embodiments described above, the liquid level is regarded as zero in a state where the liquid surface is present at the lower end of the first electrode portion E1. However, the position of the liquid surface at which the liquid level is regarded as zero is not limited to this. As one example, the liquid level may be regarded as zero in a state where the liquid surface is present at a position that is slightly above the lower end of the first electrode portion E1.

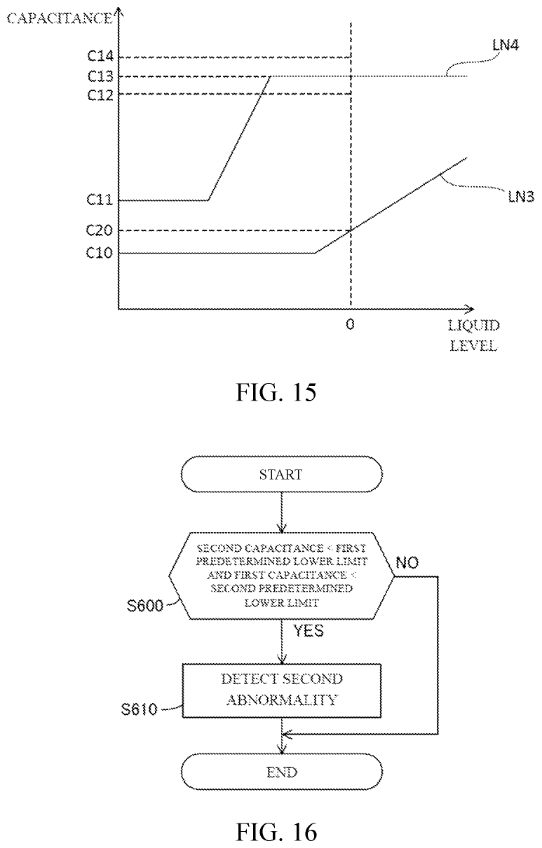

FIG. 15 depicts the relationship between the liquid level and values of capacitance for a case where the liquid level is regarded as zero in a state where the liquid surface is present at a position slightly above the lower end of the first electrode portion E1. As depicted in FIG. 15, when the liquid level is zero, the first capacitance is C20. In this case, if a relationship where the first capacitance<C20 and the second capacitance<C12 holds for example, it is highly probable that the second abnormality has occurred. Accordingly, the error judgment operation described below may be performed by the liquid sensor S1.

FIG. 16 is a flowchart depicting a procedure for detecting the second abnormality for a liquid sensor according to a second alternative embodiment. The processing depicted in this flowchart may be executed by the detection circuit 20 whenever the first and second capacitances are detected, for example.

With reference to FIG. 16, the detection circuit 20 judges whether a relationship where the second capacitance<the first predetermined lower limit value (as one example, C12 in FIG. 15) and the first capacitance<a second predetermined lower limit value (as one example, C20 in FIG. 15) holds (step S600). When it has been determined that the relationship where the second capacitance<the first predetermined lower limit value and the first capacitance<the second predetermined lower limit value does not hold (NO in step S600), the detection circuit 20 stands by until the first and second capacitances are detected again. On the other hand, when it has been determined that the relationship where the second capacitance<the first predetermined lower limit value and the first capacitance<the second predetermined lower limit value holds (YES in step S600), the detection circuit 20 detects the second abnormality (step S610).

In this way, for the liquid sensor according to the second alternative embodiment, the ranges of the first and second capacitances for a case where no abnormality occurs are known in advance. That is, by referring to the first and second capacitances, the occurrence of some kind of abnormality at the liquid sensor S1 can be detected with relatively high accuracy. According to this liquid sensor, since an abnormality at the liquid sensor is detected based on the first and second capacitances, it is possible to detect an abnormality at the liquid sensor with relatively high accuracy.

6-3

It is also possible to perform error judgment after changing the pattern of the electrodes formed on the substrate 100.

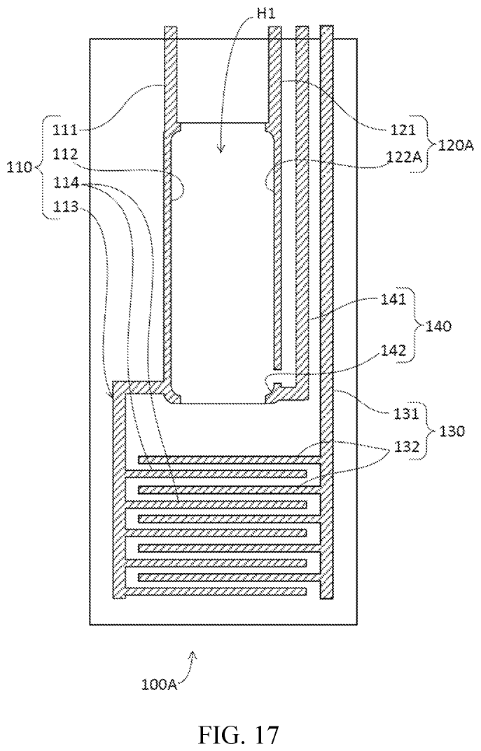

FIG. 17 is a plan view schematically depicting a substrate 100A included in a liquid sensor according to a third alternative embodiment. On the substrate 100A, a conductive portion 120A and a conductive portion 140 are provided in place of the conductive portion 120 in the embodiments described above.

The conductive portion 120A includes a wire 121 and an electrode 122A. The electrode 122A is formed on a surface of the hole H1 that faces the electrode 112 included in the conductive portion 110. That is, the electrodes 112 and 122A face each other. The conductive portion 140 also includes an electrode 142 and a wire 141. The electrode 142 is formed on the surface of the hole H1 that faces the electrode 112 included in the conductive portion 110. That is, the electrodes 112 and 142 face each other.

As one example, the electrodes 122A and 142 are constructed by splitting the electrode 122 in the embodiments described above. In a state where the substrate 100A has been immersed in a liquid, an electrode portion formed by the electrodes 112 and 142 is positioned below an electrode portion formed by the electrodes 112 and 122A.

The wire 141 is formed on the main surface of the substrate 100A and includes a part that extends in the minor axis direction and a part that extends in the major axis direction. The wire 141 electrically connects the electrode 142 and the detection circuit 20. When using the substrate 100A with the configuration described above, detection of the second abnormality may be performed according to the following procedure, for example.

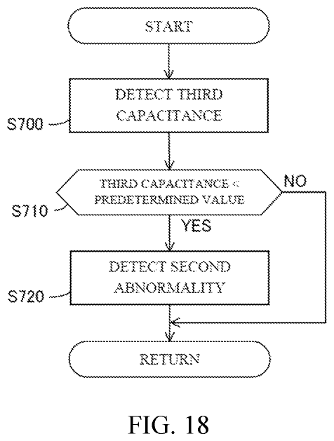

FIG. 18 is a flowchart depicting a procedure for detecting a second abnormality for a liquid sensor according to the third alternative embodiment. The processing depicted in this flowchart may be repeatedly executed by the detection circuit 20 with a predetermined cycle, for example.

With reference to FIG. 18, the detection circuit 20 detects the capacitance between the electrodes 112 and 142 (hereinafter also referred to as the “third capacitance”) by applying a voltage between the conductive portions 110 and 140 (step S700). The detection circuit 20 judges whether the third capacitance is less than a predetermined value (step S710). Note that this predetermined value corresponds for example to the capacitance between the electrodes 112 and 142 when part of the electrode 142 is immersed in a liquid, and is determined in advance through measurement or the like.

If it has been determined that the third capacitance is equal to or greater than the predetermined value (NO in step S710), the detection circuit 20 executes the processing of step S700 again. On the other hand, if it has been determined that the third capacitance is less than the predetermined value (YES in step S710), since this means that the electrode 142 is not even partially immersed in the liquid, the detection circuit 20 detects the second abnormality (step S720).

In this way, the range of the third capacitance at which the second abnormality does not occur for the liquid sensor according to the third alternative embodiment is known in advance. That is, by referring to the third capacitance, the occurrence of some kind of abnormality at the liquid sensor can be detected with relatively high accuracy. With the liquid sensor according to this third alternative embodiment, since the second abnormality at the liquid sensor S1 is detected based on the third capacitance, it is possible to detect the second abnormality at the liquid sensor with relatively high accuracy.

6-4

With the liquid sensor S1 according to the embodiment described above, the wire 131 included in the conductive portion 130 extends in parallel with the wire 111 and the electrode 112 included in the conductive portion 110. If the wire 111 and electrode 112 and additionally the wire 131 are in contact with the liquid, the capacitance between the wire 111 and electrode 112 and the wire 131 may be affected by the liquid level. As a result, the second capacitance may be affected by the liquid level. Accordingly, to suppress direct contact between the wire 131 and the liquid, as one example, part of the wire 131 may be formed in an inner layer of the substrate 100.

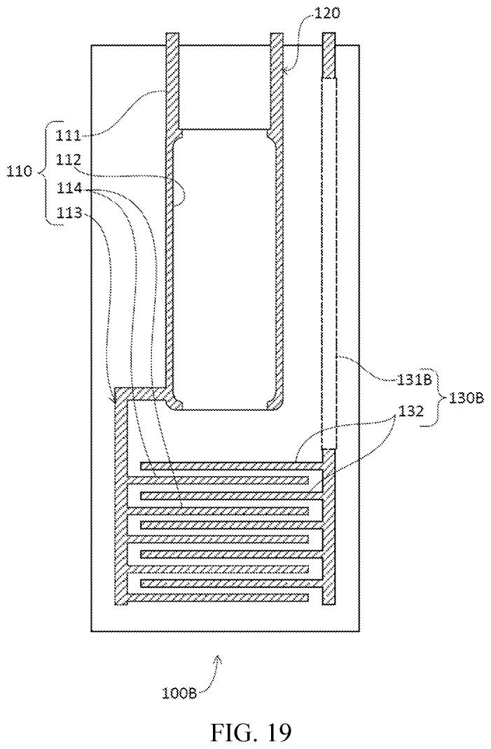

FIG. 19 is a plan view schematically depicting a substrate 100B included in a liquid sensor according to a fourth alternative embodiment. As depicted in FIG. 19, the substrate 100B includes a conductive portion 130B. The conductive portion 130B includes a wire 131B and a plurality of electrodes 132. Part of the wire 131B is formed in an inner layer of the substrate 100B. In particular, the wire 131B is formed in an inner layer of the substrate 100B at a part corresponding to the wire 111 and the electrode 112 in the major axis direction. With the liquid sensor according to this fourth alternative embodiment, since at least part of the wire 131B is formed in the inner layer of the substrate 100B, the influence of the liquid level on the second capacitance can be suppressed.

6-5

For the liquid sensor S1 according to the embodiments described above, the various control processes may be performed with consideration to the temperature of the target liquid.

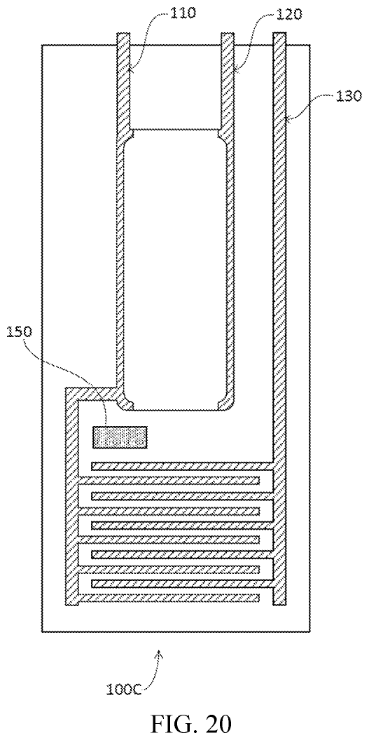

FIG. 20 is a plan view schematically depicting a substrate 100C included in a liquid sensor according to a fifth alternative embodiment. As depicted in FIG. 20, a temperature sensor 150 is mounted on the substrate 100C. The temperature sensor 150 is configured to detect the temperature of a liquid in a state where the substrate 100C is immersed in the liquid. As one example, control may be performed as described below based on the detection result of the temperature sensor 150.

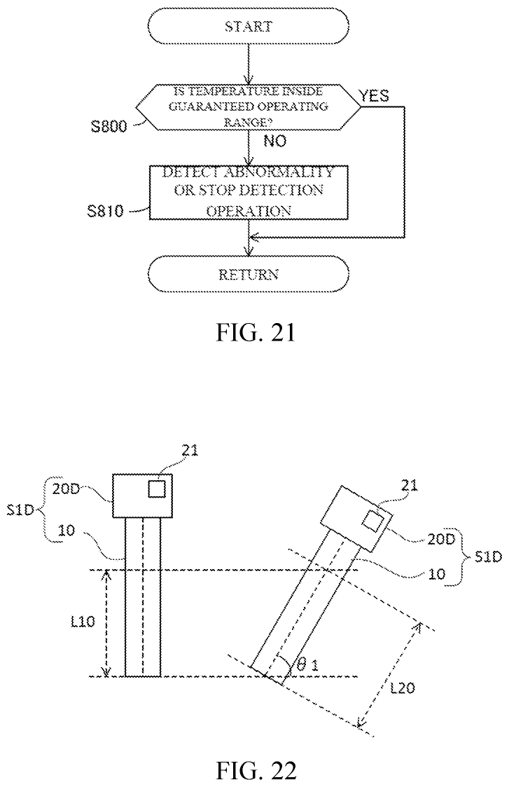

FIG. 21 is a flowchart depicting the operating procedure of the liquid sensor according to the fifth alternative embodiment. The processing depicted in this flowchart may be repeatedly executed by the detection circuit 20 at a predetermined cycle, for example, in a state where detection results produced by the temperature sensor 150 are being continuously transmitted to the detection circuit 20.

With reference to FIG. 21, the detection circuit 20 determines whether the temperature detected by the temperature sensor 150 is within a guaranteed operating range of the liquid sensor (step S800). The guaranteed operating range is, for example, a temperature range within which deterioration of the respective components included in the liquid sensor does not progress excessively when a liquid level is detected by the liquid sensor. The guaranteed operating range is defined by a lower limit value and an upper limit value of temperature, for example, and is stored in advance in the detection circuit 20.

When it has been determined that the temperature detected by the temperature sensor 150 is within the guaranteed operating range of the liquid sensor (YES in step S800), the detection circuit 20 executes the processing in step S800 again. On the other hand, when it has been determined that the temperature detected by the temperature sensor 150 is not within the guaranteed operating range of the liquid sensor S1 (NO in step S800), the detection circuit 20 detects an abnormality or stops the operation of detecting the liquid level (step S810).

With the liquid sensor according to the fifth alternative embodiment, the operating state is switched in keeping with temperature, for example. In more detail, with the liquid sensor according to this fifth alternative embodiment, detection operations are stopped when the temperature has deviated from the predetermined temperature range. Accordingly, with this liquid sensor, it is possible to suppress deterioration of the product from progressing excessively.

The respective capacitances of the first electrode portion E1 and the second electrode portion E2 are affected by temperature for reasons such as the distance between the electrodes changing according to the temperature. For this reason, at least one of the first and second capacitances may be corrected based on the temperature detected by the temperature sensor 150. As one example, after the first and second capacitances have been detected in step S200 of FIG. 9, the detected first and second capacitances may be corrected based on the temperature. After this, the processing from step S210 onward may be performed using the corrected first and second capacitances.

In this way, in the liquid sensor according to the fifth alternative embodiment, at least one of the first capacitance and the second capacitance may be corrected based on the detection result of the temperature sensor 150. According to this liquid sensor, since the influence of temperature on at least one of the first capacitance and the second capacitance is taken into consideration, the liquid level can be detected with higher accuracy than when the influence of temperature is not considered.

6-6

In the liquid sensor S1 according to the embodiment described above, the liquid level may be detected while taking any tilting of the liquid sensor S1 into consideration.

FIG. 22 is a diagram illustrating a procedure for detecting a liquid level with a liquid sensor SID according to a sixth alternative embodiment. With reference to FIG. 22, the liquid sensor S1D includes a liquid sensor main body 10 and a detection circuit 20D. As one example, the detection circuit 20D includes a CPU, a RAM, and a ROM. The detection circuit 20D detects the first and second capacitances using various known techniques. The detection circuit 20D detects the liquid level based on a detected capacitance.

The detection circuit 20D further includes an angle sensor 21. The angle sensor 21 detects tilting (that is, the angle) of the liquid sensor S1D. The detection circuit 20D uses the detection result of the angle sensor 21 to correct the liquid level.

As one example, when the liquid sensor S1D is tilted as depicted on the right side of FIG. 22, the liquid level indicated as L20 may be detected when tilting of the liquid sensor S1D is not taken into consideration. However, the liquid level indicated as L10 should actually be detected. With the liquid sensor S1D according to the sixth alternative embodiment, tilting of the liquid sensor S1D is detected by the angle sensor 21, and the liquid level is corrected with consideration to such tilting of the liquid sensor S1D. That is, the liquid level is corrected based on Equation (4) below. By doing so, the liquid level L10 is detected.

$$L ( liquid level ) = L 20 \times Sin θ 1 \qquad ( 4 )$$

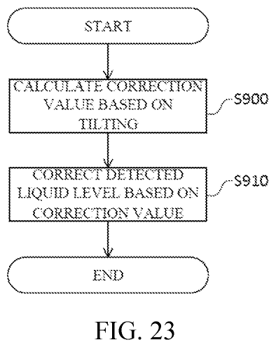

FIG. 23 is a flowchart depicting a procedure for correcting the liquid level in the liquid sensor S1D according to the sixth alternative embodiment. As one example, the processing depicted in this flowchart may be executed by the detection circuit 20D whenever a liquid level is detected, in a state where detection results produced by the angle sensor 21 are being continuously transmitted to the detection circuit 20D.

With reference to FIG. 23, the detection circuit 20D calculates a correction value based on the angle (tilting) detected by the angle sensor 21 (step S900). In more detail, the detection circuit 20D calculates the sine value of the angle detected by the angle sensor 21. The detection circuit 20D corrects the detected liquid level based on the correction value (step S910). In more detail, the detection circuit 20D corrects the liquid level by multiplying the detected liquid level by the sine value calculated in step S900. Note that detection of the liquid level is performed by the same method as the liquid sensor S1 according to the embodiments described above.

According to this liquid sensor S1D, since the detected liquid level is corrected based on the detection result of the angle sensor 21, the liquid level can be detected with higher accuracy than when the tilting of the liquid sensor is not taken into consideration.

6-7

In the liquid sensor S1 according to the above embodiment, the conductive portion 110 is shared by the first electrode portion E1 and the second electrode portion E2. However, the respective configurations of the first electrode portion E1 and the second electrode portion E2 are not limited to this. As one example, it is possible for the first electrode portion E1 and the second electrode portion E2 to not use a shared conductive portion and to add a separate conductive portion so that the first electrode portion E1 and the second electrode portion E2 are constructed of completely different conductive portions.

6-8

The second capacitance detected by the liquid sensor S1 according to the embodiments described above may be used to determine a degree of deterioration of the liquid, for example. As one example, the second capacitance when the substrate 100 is first immersed in the liquid may be stored in the detection circuit 20, and the detection circuit 20 may monitor changes in the second capacitance to determine a degree of deterioration of the liquid.

6-9

Also, in the above embodiments, each process performed using a capacitance may be performed using a dielectric constant after such dielectric constant has been calculated based on a capacitance.

6-10

In the embodiment described above, the second electrode portion E2 is constructed of a pair of comb electrodes. However, the second electrode portion E2 does not need to be constructed of a pair of comb electrodes. As one example, like the first electrode portion E1, the second electrode portion E2 may also be constructed of a pair of electrodes provided on an inner circumferential surface of the substrate 100 formed by a hole.

Several embodiments of the present invention have been described above as examples. That is, the detailed description and accompanying drawings are provided for illustrative purposes. Accordingly, the components indicated in the detailed description and the attached drawings may include components that are not essential for solving the technical problem. Accordingly, the inclusion of such non-essential components in the detailed description and accompanying drawings should not be interpreted as non-essential components being essential.

The embodiments described above are exemplary in all aspects of the present invention. The embodiments described above can be subjected to various changes and modifications within the scope of the present invention. That is, when implementing the present invention, it is possible to use an appropriate specific configuration in keeping with that particular implementation.

### LIST OF REFERENCE NUMERALS

10 Liquid Sensor Main Body
15 Plug
20, 20D Detection circuit
21 Angle sensor
30 Cable
100, 100A, 100B, 100C Substrate
101 Inner peripheral surface
110, 120, 120A, 130, 130B, 140 Conductive portion
111, 113, 121, 131, 131B, 141 Wire
112, 114, 122, 122A, 132, 142 Electrode
115 First part
116 Second part
150 Temperature sensor
CX1 Capacitance
CX2 Parasitic capacitance
E1 First electrode portion
E2 Second electrode portion
H1 Hole
LN1, LN2, LN3, LN4 Line
S1, S1D Liquid sensor

1. A liquid sensor that detects a liquid level in a state where at least part of the liquid sensor is immersed in a liquid,
the liquid sensor comprising a substrate,
wherein a plurality of electrodes are formed on the substrate,
a first electrode portion is composed of a first pair of electrodes included in the plurality of electrodes,
a second electrode portion is composed of a second pair of electrodes included in the plurality of electrodes,
a hole is formed in the substrate,
the first pair of electrodes are formed on an inner peripheral surface of the substrate formed by the hole, and
the second electrode portion is positioned below the first electrode portion in a state where the liquid sensor is immersed in the liquid.

2. The liquid sensor according to claim 1,
further comprising a detection circuit that detects a first capacitance at the first electrode portion and a second capacitance at the second electrode portion,
wherein the detection circuit detects the liquid level based on the first capacitance and the second capacitance.

3. The liquid sensor according to claim 2,
wherein the detection circuit corrects the first capacitance based on the second capacitance and detects the liquid level based on the first capacitance after correction.

4. The liquid sensor according to claim 2,
wherein the detection circuit detects the liquid level based on the first capacitance and corrects the detected liquid level based on the second capacitance.

5. The liquid sensor according to claim 2,
wherein the detection circuit detects an abnormality at the liquid sensor based on the second capacitance.

6. The liquid sensor according to claim 2,
wherein a third electrode portion is constructed by a pair of third electrodes included in the plurality of electrodes,
the pair of third electrodes is formed on the inner peripheral surface,
the third electrode portion is positioned below the first electrode portion in a state where the liquid sensor is immersed in the liquid,
the detection circuit detects a third capacitance at the third electrode portion, and
the detection circuit detects an abnormality at the liquid sensor based on the third capacitance.

7. The liquid sensor according to claim 2,
wherein a wire that electrically connects the second electrode portion and the detection circuit is formed on the substrate,
at least part of the wire extends along the first pair of electrodes, and
at least part of the wire is formed in an inner layer of the substrate.

8. The liquid sensor according to claim 2,
further comprising a temperature sensor mounted on the substrate,
wherein the detection circuit switches an operating state in keeping with a detection result of the temperature sensor.

9. The liquid sensor according to claim 2,
further comprising a temperature sensor mounted on the substrate,
wherein the detection circuit corrects at least one of the first capacitance and the second capacitance based on a detection result of the temperature sensor.

10. The liquid sensor according to claim 2,
further comprising an angle sensor,
wherein the detection circuit corrects the detected liquid level based on a detection result of the angle sensor.

11. The liquid sensor according to claim 3,
wherein the detection circuit detects an abnormality at the liquid sensor based on the second capacitance.

12. The liquid sensor according to claim 4,
wherein the detection circuit detects an abnormality at the liquid sensor based on the second capacitance.

13. The liquid sensor according to claim 3,
wherein a third electrode portion is constructed by a pair of third electrodes included in the plurality of electrodes,
the pair of third electrodes is formed on the inner peripheral surface,
the third electrode portion is positioned below the first electrode portion in a state where the liquid sensor is immersed in the liquid,
the detection circuit detects a third capacitance at the third electrode portion, and
the detection circuit detects an abnormality at the liquid sensor based on the third capacitance.

14. The liquid sensor according to claim 4,
wherein a third electrode portion is constructed by a pair of third electrodes included in the plurality of electrodes,
the pair of third electrodes is formed on the inner peripheral surface,
the third electrode portion is positioned below the first electrode portion in a state where the liquid sensor is immersed in the liquid,
the detection circuit detects a third capacitance at the third electrode portion, and
the detection circuit detects an abnormality at the liquid sensor based on the third capacitance.

15. The liquid sensor according to claim 3,
wherein a wire that electrically connects the second electrode portion and the detection circuit is formed on the substrate,
at least part of the wire extends along the first pair of electrodes, and
at least part of the wire is formed in an inner layer of the substrate.

16. The liquid sensor according to claim 4,
wherein a wire that electrically connects the second electrode portion and the detection circuit is formed on the substrate,
at least part of the wire extends along the first pair of electrodes, and
at least part of the wire is formed in an inner layer of the substrate.

17. The liquid sensor according to claim 3,
further comprising a temperature sensor mounted on the substrate,
wherein the detection circuit switches an operating state in keeping with a detection result of the temperature sensor.

18. The liquid sensor according to claim 4,
further comprising a temperature sensor mounted on the substrate,
wherein the detection circuit switches an operating state in keeping with a detection result of the temperature sensor.

19. The liquid sensor according to claim 3,
further comprising a temperature sensor mounted on the substrate,
wherein the detection circuit corrects at least one of the first capacitance and the second capacitance based on a detection result of the temperature sensor.

20. The liquid sensor according to claim 3,
further comprising an angle sensor,
wherein the detection circuit corrects the detected liquid level based on a detection result of the angle sensor.
